(19) United States
(12) Patent Application Publication
(10) Pub. No.: US 2009/0097953 A1
(43) Pub. Date: Apr. 16, 2009

(54) DEVICE FOR MOVING PACKAGES AND METHODS OF USING THE SAME

(75) Inventors: Jerome Brugger, Melbourne, KY (US); Matthew R. Lukes, Independence, KY (US)

Correspondence Address: WOOD, HERRON & EVANS, LLP, 2700 CAREW TOWER, 441 VINE STREET, CINCINNATI, OH, 45202, US

(73) Assignee: R.A. JONES & CO., INC., Covington, KY (US)

(21) Appl. No.: 12/249,908

(22) Filed: Oct. 11, 2008

Related U.S. Application Data
(60) Provisional application No. 60/979,636, filed on Oct. 12, 2007.

(51) Int. Cl. B65G 47/91

(52) U.S. Cl. 414/627; 294/64.3; 414/806; 414/752.1

(57) ABSTRACT

A device for operating on a package includes a housing having a portion adapted to be coupled to the package, and a fan coupled to the housing for generating a vacuum within the housing to selectively retain or release the package relative to the housing. A method of operating on the package includes decreasing a distance between the housing and the package, actuating the fan coupled to the housing to generate a vacuum therein, retaining the package relative to the housing using the vacuum generated by the fan, and releasing the vacuum in the housing to release the package relative to the housing.

### CROSS REFERENCE TO RELATED APPLICATIONS

This application claims priority to U.S. provisional patent application Ser. No. 60/979,636 filed on Oct. 12, 2007, the disclosure of which is expressly incorporated by reference herein in its entirety.

### TECHNICAL FIELD

The invention relates generally to apparatus for moving or re-orienting objects and, more particularly, to a vacuum driven apparatus for moving or re-orienting packaged objects.

### BACKGROUND

Consumer products such as food items may come in packages of different shapes and sizes and may include loosely bagged products such as crackers, cookies and candies, flow-wrapped products such as energy bars, and thermo-sealed products such as frozen foods. Consumer products of this type are in some instances packaged as described above, and the resulting package transported to a cartoning device for further processing or packaging.

Known systems for moving, re-orienting or otherwise manipulating packages typically include a conveyor belt carrying product feed randomly spaced thereon from, for example, an upstream packaging device. A controllable transport device, such as a robot, pick-and-place device, or other such device, is then used to identify the randomly spaced packages and move and/or re-orient the packages for further processing. For example, the transport device may place the packages within a bucket of a cartoning device in a certain orientation. In this regard, the transport device typically includes an extension arm having an engagement device or the like at an end thereof for picking up or retaining the packages thereto. In some systems of this type, a vacuum pump is located remotely from the engagement device and provides a relatively large negative pressure (i.e., vacuum) and low airflow rate in order to retain the package to the engagement device. A conduit line may connect the vacuum pump to the engagement device and includes valves and other controls for regulating the airflow therethrough. In operation, the extension arm is moved such that the engagement device contacts an exposed surface of the package. The vacuum pump is then energized and creates a vacuum that retains the package to the engagement device. The arm is then moved to a different location, such as in proximity to a bucket of a cartoning device, and the vacuum pump de-energized so as to release the package from the engagement device. Alternatively, the vacuum pump may constantly be energized and the valving used to generate and release the vacuum pressure at the engagement device.

Systems of this type have some drawbacks however. For example, vacuum pump-type systems are known to be generally complex, require large spaces, and are energy inefficient. Moreover, some of these systems are such that response times for retaining and releasing the packages are relatively slow or long, thereby limiting the overall speed of operation of the transport device. The relatively large response time may be due to the relatively large volume of air in the conduit line between the vacuum pump and engagement device (i.e., the pump must act on a relatively large volume of air before any effect occurs at the engagement device). Systems of this type are also generally intolerant to any gaps or leaks between the package and the engagement device. Such leaks are not uncommon and may result in a loss of retention of the package by the engagement device. This may happen, for instance, in cases of rolling of the package relative to the engagement device, which typically occurs at higher operating rates due to the increased inertial forces, or when bunching of portions of the package occurs. In any event, the relatively large response times and lack of leak tolerance limits the overall speed of operation of the transport device. For example, current transport devices using vacuum pumps achieve at most approximately 40 pick-and-place operations per minute. In addition to the above, the valving for these systems is costly and typically requires custom manufacturing. The conduit line coupling the vacuum pump to the engagement devices is also large and occupies a large amount of space.

Other types of systems also exist. For example, some systems use a low airflow venturi device to provide the vacuum at the engagement device that retains the package thereto. In this regard, a compressed air source may be located remotely from the engagement device and is coupled to the venturi device located on the engagement device through a conduit line. These venturi devices typically produce relatively high negative pressures and low airflow rates into the engagement device. Like the vacuum pump-driven systems described above, systems of this type also include relatively long response times. Such long response times may be due, for example, to the restricted orifice in the venturi device itself. In a similar manner, the low airflow rates of systems of this type result in an intolerance for gaps or leaks of air between the package and the engagement device. As noted above, such leaks are not uncommon and may result in a loss of retention of the package by the engagement device.

Accordingly, it would be desirable to have a system that permits picking up and moving packages which address these and other drawbacks of conventional systems.

### SUMMARY

Embodiments of the invention address these and other drawbacks and include a device for moving a package having a housing with a portion adapted to be coupled to the package, and at least one fan coupled to the housing for generating a vacuum within the housing for selectively retaining or releasing the package relative to the housing. In one embodiment, the fan may be carried by the housing. The fan includes a fan housing, a blade assembly having a plurality of blades and disposed in the fan housing, and a motor coupled to the blade assembly for rotating the blades so as to induce an airflow sufficient to generate a vacuum within the housing. In one embodiment, the blades may be movable so as to vary a leading angle of the blades.

A system for transporting a package includes a transport member having an engagement member configured for moving between a first and second position. The system also includes a housing having a first end adapted to be coupled to the package and a second end coupled to the engagement member, and at least one fan coupled to the housing, wherein actuation of the fan generates a vacuum within the housing for selectively retaining or releasing the package relative to the first end of the housing.

A method of moving a package includes decreasing a distance between the housing and the package, actuating a fan coupled to the housing to generate a vacuum therein, retaining the package relative to the housing using the vacuum generated by the fan, and releasing the vacuum in the housing to release the package relative to the housing. In one embodiment, actuating the fan may include energizing the fan to thereby generate the vacuum in the housing. Alternatively, actuating the fan may include increasing a leading angle of blades of the fan to thereby generate the vacuum in the housing. Moreover, releasing the vacuum in the housing may include de-energizing the fan to release the vacuum and thereby release the package from the housing. Alternatively, releasing the vacuum in the housing may include decreasing the leading angle of the blades of the fan so as to release the vacuum and release the package from the housing.

### BRIEF DESCRIPTION OF THE FIGURES

FIG. 1 is a perspective view of a transport system in accordance with an embodiment of the invention;

FIG. 2 is a perspective view of an engagement device in accordance with an embodiment of the invention;

FIG. 3 is a side elevation view of the engagement device shown in FIG. 2;

FIG. 4 is a front view of the engagement device shown in FIG. 2;

FIG. 5 is a cross-sectional view of the engagement device shown in FIG. 2;

FIG. 6 is a side view of a fan in accordance with an embodiment of the invention;

FIG. 7 is a top view of the engagement device shown in FIG. 2;

FIG. 8 is a bottom view of the engagement device shown in FIG. 2;

FIG. 9 is a perspective view of an engagement device in accordance with another embodiment of the invention;

FIG. 10 is a side elevation view of the engagement device shown in FIG. 9;

FIG. 11 is a front view of the engagement device shown in FIG. 9;

FIG. 12 is a cross-sectional view of the engagement device shown in FIG. 9;

FIG. 13 is a top view of the engagement device shown in FIG. 9; and

FIG. 14 is a bottom view of the engagement device shown in FIG. 9.

### DETAILED DESCRIPTION

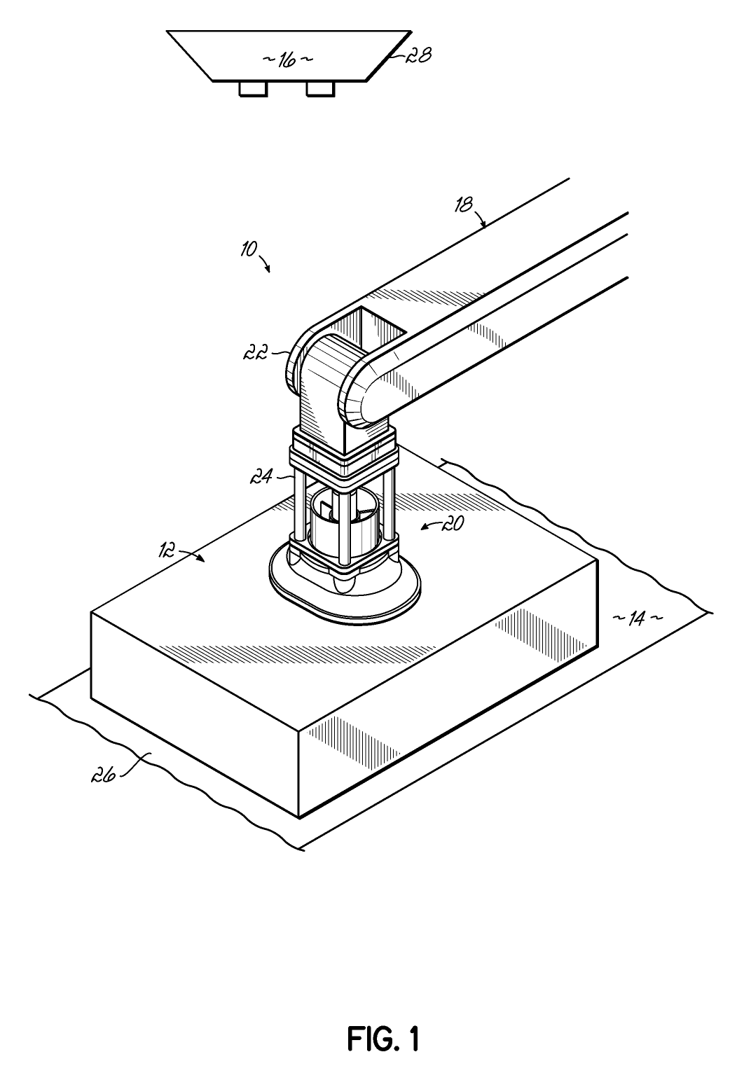

With reference to FIG. 1, a system 10 is configured for moving a package 12 between a first position 14 and a second position 16. To this end, the system 10 includes an engagement member 18, such as an end of a tooling flange, an extension arm, or other connector, which is coupled to a transport member (not shown), such as a robot, pick-and-place device or other device, for moving packages, and an engagement device 20 coupled to a first end 22 of the engagement member 18 via a mounting structure 24 disposed on engagement device 20. The engagement member 18 and engagement device 20 are configured so as to pick up and retain the package 12 at the first position 14 and move it to the second position 16 where it is released from engagement device 20. For example, the engagement member 18 may be configured to pick up package 12 from a conveyor belt 26 and move it to a bucket, shown schematically at 28, or the like of a cartoning device or another conveyor belt (not shown). The engagement device 20 may be used to retain/release a broad range of packages including well-defined, easy to grip packages (e.g., boxes and the like) or poorly-defined, difficult to grip packages (e.g., loosely packaged items, pouches, etc.). Moreover, as used herein, the package 12 may include an individual item or a group of items and should not be limited to specific configurations thereof. The group of items may be formed prior to being acted on by the engagement device or the group of items may be formed by acting on a plurality of items in a sequential manner using the engagement device. The details of the engagement device 20 and the manner in which the package 12 is retained thereto will now be described in detail.

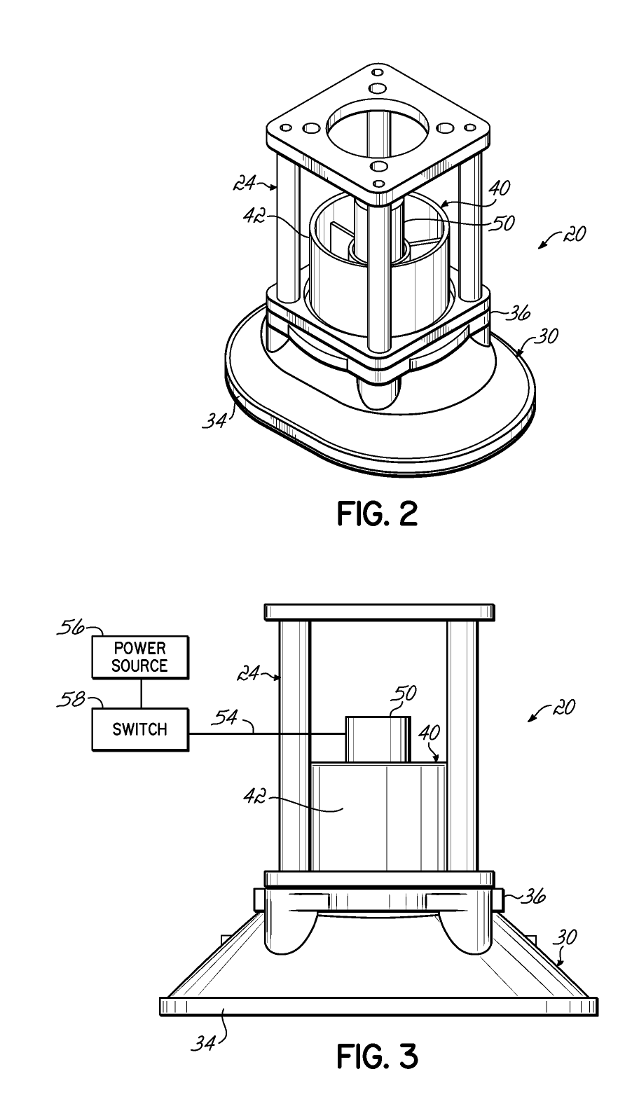

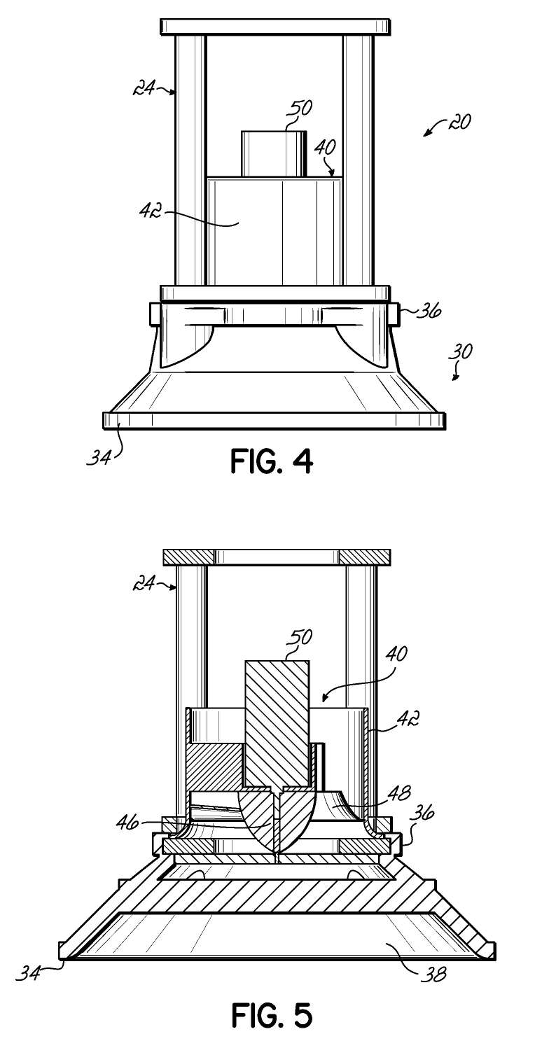

As shown in FIGS. 2-8, the engagement device 20 includes a housing 30 and a pressure generator coupled to housing 30 for generating a vacuum (i.e., negative pressure) that retains the package 12 to the engagement device 20, as shown in FIG. 1. The housing 30 includes a first end 34, a second end 36, and an open cavity 38 disposed therebetween (FIG. 5). The second end 36 may be coupled to the first end 22 of the engagement member 18 via mounting structure 24 in a conventional manner, such as with threaded fasteners or the like, such that the engagement device 20 is movable with movement of the engagement member 18. The first end 34 of the housing 30 is configured to be coupled to at least a portion of the package 12, such as at an upper surface thereof (FIG. 1). The first end 34 may be larger than the second end 36 such that cavity 38 has a generally conical shape, although it is not so limited. The cavity 38 provides sufficient space to expose the package 12 to vacuum pressure from the pressure generator. The housing 30 may be formed from a rigid material, a flexible material, or a combination of rigid and flexible materials. For example, housing 30 may include flexible vacuum cups as generally known in the art and commercially available. Alternatively, the housing 30 may include a flexible first end 34 for facilitating coupling to package 12 and a generally rigid second end 36 for coupling to the engagement member 18. Furthermore, the housing 30 may be specifically configured to meet the requirements of specific applications. Thus, for example, housing 30 may be configured to operate with packages 12 having a wide variety of shapes and sizes.

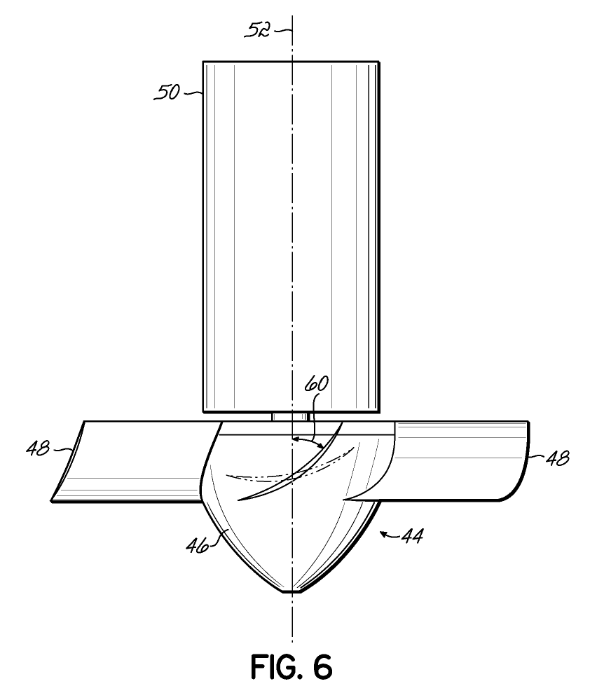

In one embodiment, the pressure generator may be a fan 40 coupled to the housing 30, and more particularly, coupled to the second end 36 of the housing 30 and in fluid communication with cavity 38. The fan 40 includes a generally cylindrical fan housing 42 coupled to the second end 36 of housing 30. As shown in FIG. 6, the fan housing 42 includes a blade assembly 44 having a central hub 46 and a plurality of blades 48 disposed therein. For example, the blade assembly 44 may include between 2 and 7 blades depending on the specific application. The central hub 46 is coupled to a shaft of an electric motor 50 coupled to the fan housing 42 and capable of rotating the blade assembly 44 about a central axis 52. Motor 50 is energizable via electrical wires 54 operatively coupling the motor 50 to a source of electric power, shown schematically at 56. A switch 58 or other similar device may be used to control the flow of electrical energy from the source 56 to the motor 50, thereby energizing/de-energizing motor 50 and correspondingly, fan 40. The term fan is used broadly herein and generally encompasses devices that generate or motivate the flow of air through the movement of a blade, impeller, or other such member. Those of ordinary skill in the art will recognize modifications to the fan so as to optimize its use in certain applications.

The size of the fan 40 in accordance with aspects of the invention is relatively small. For example, in one exemplary embodiment, the blade assembly 44 may be approximately 56 mm in diameter with five (5) blades thereon having a fan swept area of approximately 17.5 cm² and configured to be coupled to a 114 Watt DC motor. The motor is operational at approximately 29,000 rpms to generate approximately 240 grams of static thrust, have a fan efflux speed of approximately 32.4 m/s and generate a volumetric airflow rate of approximately 56.7 liters/sec. This exemplary fan when coupled to engagement device 20 is capable of creating approximately 1 kPa of vacuum pressure. As recognized by those of ordinary skill in the art, increasing the surface area of the object to which the vacuum is applied allows for heavier objects to be carried.

Components for this type of fan 40 are commercially available from various vendors, such as Grand Wing Systems of City of Industry, Calif.; Electrifly of Champaign, Ill.; WeMoTec GbR, of Germany; Maxon Motor Ag, of Germany; and MicroMo Electronics, Inc., of Clearwater, Fla. The fan 40, as described above, provides the advantages of being energy efficient, lightweight, and includes electronic switching that allows the fan 40 to be switched on and off very quickly. Moreover, it is expected that the fan 40 can reach its design speed in a matter of milliseconds, thereby providing high volume airflow essentially on demand.

In accordance with aspects of the invention, fan 40 should be capable of generating sufficient airflow to facilitate the movement of packages of various shapes, sizes, configurations, and surface texture so as to meet the demands of specific applications. For example, fan 40 may be configured to provide a volumetric airflow rate of between approximately 10 liters/sec to approximately 1,000 liters/sec, and possibly higher, at approximately 1 kPa of vacuum pressure. In one embodiment, the fan 40 may be sized and configured to generate volumetric airflow rates of greater than about 300 liters/sec and obtain a vacuum pressure of approximately 1 kPa. Additionally, fan 40 may be configured to achieve higher vacuum pressures. In this regard, fan 40 may be configured to achieve vacuum pressures as high as 5 kPa through use of, for example, multi-stage compressor fans. Accordingly, fan 40 is adaptable to a wide range of applications.

One aspect of the present invention is that the high volumetric airflow rates may be achieved at relatively low vacuum pressures, which stands in contrast with other conventional systems. For example, venturi systems can achieve fairly high vacuum pressures (e.g., 5-60 kPa), but have relatively low volumetric airflow rates (e.g., typically no greater than 24 liters/sec). Vacuum-pump systems, although capable of achieving increased volumetric airflow rates (e.g., 15-300 liters/sec) and relatively high vacuum pressures (e.g., 5-25 kPa), generally require the use of large motors that require remote placement of the motor. In contrast, fan 40 may achieve volumetric airflow rates in a range of approximately 10 liters/sec to approximately 1000 liters/sec while maintaining vacuum pressures in a range of less than approximately 1 kPa to approximately 5 kPa.

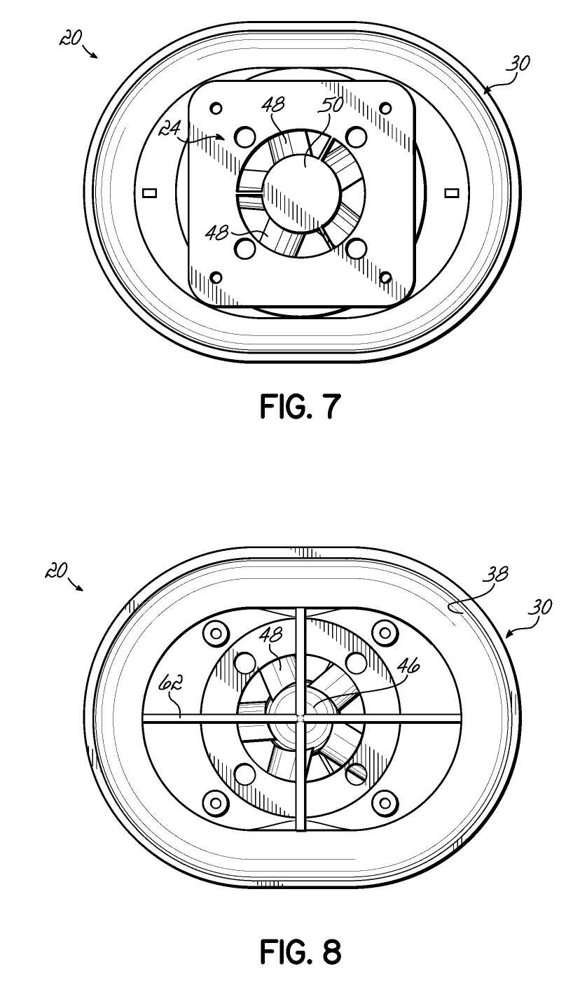

In operation, as the engagement member 18 is moved toward a package 12, the motor 50 is energized, such as by a suitable controller (not shown), so as to rotate the blade assembly 44. The rotation of the blade assembly 44 initiates a relatively high airflow rate into the engagement device 20 and toward fan 40, which in turn generates vacuum pressure within cavity 38. The high airflow rate directs or draws the package 12 toward the engagement device 20 and the vacuum pressure retains the package 12 thereto. With the package 12 secured to the engagement device 20, the engagement member 18 may lift and move the package 12 from the first position 14, such as on conveyor belt 26, to the second position 16, such as in bucket 28, as shown in FIG. 1. When the engagement member 18 is moved to the second position 16, the motor 50 may be de-energized. Upon de-energizing the motor 50, air may rush into the cavity 38 through, for example, the upper end of the fan housing 42 and through the gap between adjacent blades 48 (FIG. 7). The inflow of air releases the vacuum, wherein the package 12 releases from the engagement device 20. Accordingly, energizing/de-energizing motor 50 allows package 12 to be retained and released from engagement device 20.

The engagement device 20, or systems 10 employing such a engagement device 20, provide a number of advantages over existing systems. For example, in one embodiment the fan 40 is relatively small and may be carried directly on the engagement device housing 30. Locating the pressure generator (e.g., fan 40) at the engagement device 20 decreases response time. For example, there is no need for any large conduit line between the engagement device and an external vacuum source. Additionally, the motor 50 is capable of being switched on and off very quickly and is further capable of reaching its operational state (e.g., design speeds or rpms) very quickly. This again improves the response time of the system. Moreover, when the motor is de-energized, the vacuum is released quickly due to the relatively large flow path for air to enter the cavity 38 (e.g., between fan blades 48). This is in stark contrast to venturi systems, for example, that have flow through a restricted orifice to release the vacuum. This aspect further improves response times.

Another advantage is that the engagement device 20 as described above is tolerant to leaks at the engagement device/packaging interface. As explained above, existing systems are intolerant to leaks such that when a leak occurs, the package may be undesirably released from the engagement device. These leaks may be due to a poor seal with the package or due to rolling of the package on the engagement device as a result of relatively large inertial forces. Accordingly, to prevent such a result, existing systems have to run at a relatively low speed so as to keep inertial forces low. As noted above, however, fan 40 generates a relatively high airflow rate into the housing 30 of engagement device 20 for a given vacuum pressure. Thus, if a leak forms at the engagement device/package interface, the high airflow rate tends to drag the package back toward the engagement device 20 so as to re-establish the seal therebetween or at least retain the package 12 to the engagement device 20 despite the leaks. Thus, the engagement device 20 (and system 10) is very robust and is capable of operating at increased operational speeds. For example, it is expected that pick-and-place operation rates of between approximately 130 and approximately 180 or more operations per minute may be achieved using engagement device 20 as described above. Presently, the pick-and-place operation rates utilizing engagement device 20 is limited by capabilities of the transport member (e.g., robot). Thus, it is believed that even higher pick-and-place operation rates may be achieved with this device as more efficient transport members are developed. Furthermore, and as noted above, the motor 50 is energy efficient. Moreover, the engagement device 20 is lightweight, has relatively few parts, and is capable of being maintained in a cost effective manner. For example, it is contemplated that the fan 40, including fan housing 42, blade assembly 44, and motor 50 may be quickly and easily replaced as a sub-assembly, which decreases the time required for repairs and retooling.

As described above, the package 12 may be retained and released from the engagement device 20 by actuating the pressure generator, such as energizing/de-energizing the motor 50 of fan 40. In another embodiment, however, the package 12 may be retained/released relative to engagement device 20 by actuating the pressure generator in a different manner. For example, in this embodiment each of the blades 48 of blade assembly 44 defines a pitch or lead angle 60 (FIG. 6) that determines the amount of airflow through housing 30 when blades 48 rotate. For example, when the blades 48 have a lead angle of approximately zero, very little to no airflow occurs, and when the lead angle 60 increases, the amount of airflow into the engagement device 20 and through the fan 40 increases. Accordingly, by controlling the lead angle 60 of the blades 48, the airflow, and thus the generation of the vacuum within the cavity 38, may be controlled without switching the motor 50 on and off. Thus, in this embodiment, fan 40 may include a mechanism (not shown) that permits controllable adjustment of the lead angle 60 even during rotation of the blades 48 (dynamic adjustment). Electric or pneumatic solenoids are non-limiting examples of mechanisms for adjusting the lead angle of the fan blades 48. Those of ordinary skill in the art may recognize other mechanisms for controlling the pitch of the blades 48 that are within the scope of the invention.

In operation, the motor 50 may continually operate at its design speed. Initially, the blades 48 may be positioned to have a substantially zero lead angle 60 so that there is essentially no flow (and no vacuum) in the engagement device 20. As the engagement member 18 is moved toward a package 12, the blades 48 may be rotated or otherwise moved so as to increase the lead angle 60 of blades 48 to a suitable value. With the blades 48 at the operational lead angle 60, a relatively high airflow rate may be established through the engagement device 20 so as to generate a vacuum in cavity 38. As before, the high airflow rate directs or draws the package 12 toward the engagement device 20 and the vacuum pressure retains the package 12 thereto. With the package 12 secured to the engagement device 20, the engagement member 18 may lift and move the package 12 from the first position 14, such as on conveyor belt 26, to the second position 16, such as in bucket 28. When the engagement member 18 is moved to the second position, the blades 48 may be returned to the near zero lead angle 60, thereby allowing air to rush into the cavity 38 through the upper end of the fan housing 42 and through blades 48 to release the vacuum and cause the package 12 to release from the engagement device 20.

The lead angle 60 of the blades 48 so as to effectively release the package 12 from engagement device 20 is not limited to zero or near zero as described above. For example, the lead angle 60 may be slightly above zero so long as the package 12 releases from the engagement device 20. Additionally, the blades 48 may be moved so as to have a slight negative lead angle so as to actively push air into the cavity 38 to release the vacuum when it is desired to release the package 12 therefrom.

While switching between the pick-up mode (generating a vacuum) and release mode (decreasing the vacuum) has been discussed in terms of energizing and de-energizing a motor coupled to a fan, or varying the pitch of the fan blades, it is contemplated that other methods of releasing the vacuum and thus the package may be used in accordance with aspects of the invention. Non-limiting examples include injecting air into the space between the package and the pressure generator, actuating a butterfly valve to block or divert the flow of air through the pressure generator, or opening and closing louvers or valves in the housing to allow air to flow into the housing between the package and the pressure generator. Such alternative methods break the vacuum seal with the package and allow the package to release from the engagement device.

Engagement device 20 may be configured to retain package 12 thereto while preventing portions thereof from contacting and/or being entangled by the moving blades 48 of fan 40. In this regard, the housing 30 may include a grid member 62 (FIG. 8) disposed adjacent fan 40 that prevents package 12 from entering the fan 40. Additionally, grid member 62 may optionally provide structural rigidity to housing 30. While grid member 62 is depicted as a cross-shaped member, it is contemplated that other shapes or configurations may be alternatively employed.

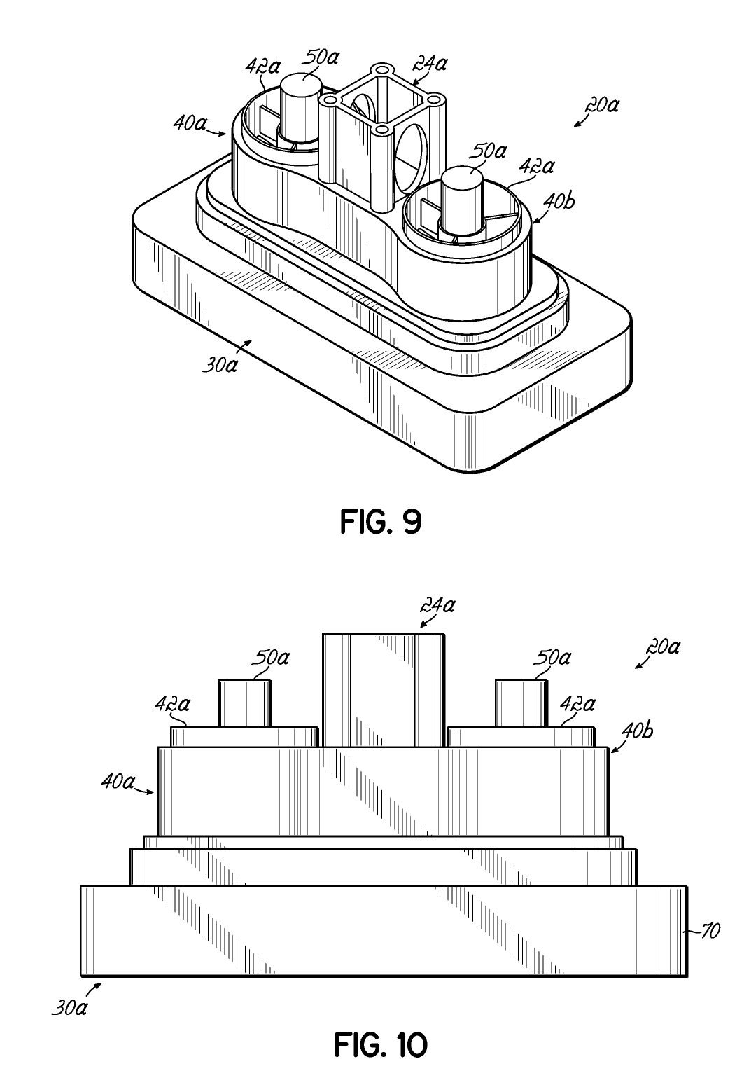

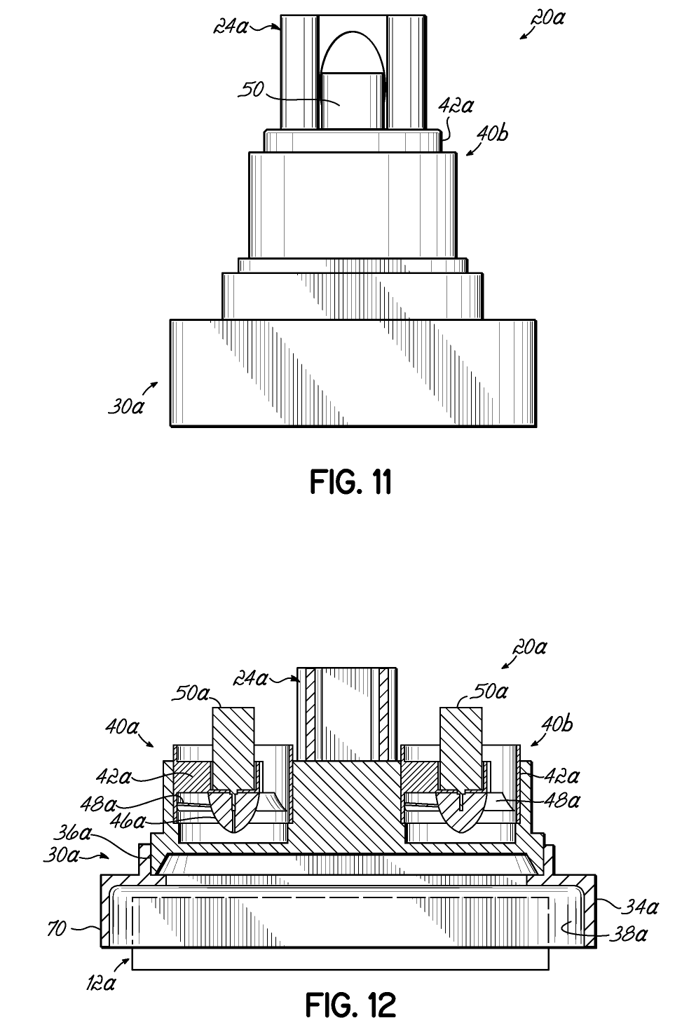

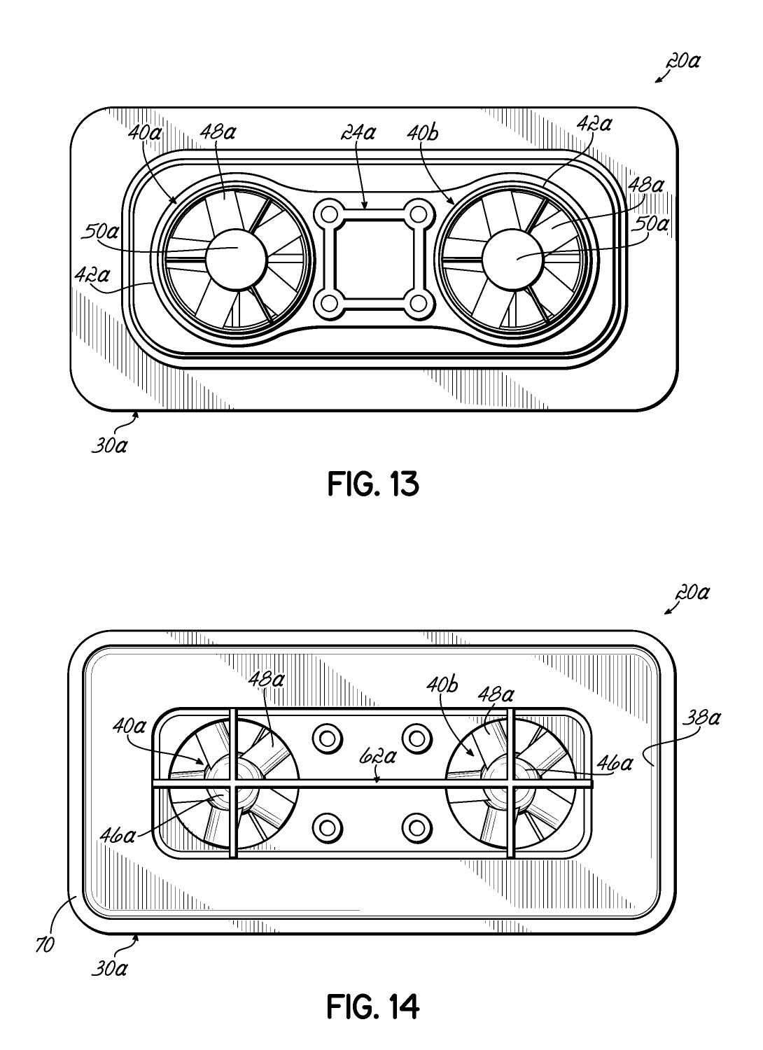

With reference to FIGS. 9-14, in which like features have similar reference numerals but with a letter suffix added thereto, engagement device 20a is similar in most respects to engagement device 20 of FIGS. 1-8. The following description will focus on the modifications to engagement device 20a relative to engagement device 20. Engagement device 20a includes a housing 30a having first and second fans 40a, 40b in a generally side-by-side arrangement coupled thereto. The fans 40a, 40b operate in the manner similar to that described above so as to retain and release a package 12a to/from engagement device 20a. The multi-fan configuration shown in this embodiment may be used, for example, for larger or heavier packages. For example, if the package has a weight such that a single fan cannot generate a vacuum sufficient to retain the package to the engagement device, additional fans may be added. Similarly, if the size of the package is large, additional fans may be used to achieve the pick-and-place operation. The use of a single fan 40 or two such fans 40a, 40b are exemplary and those of ordinary skill in the art will recognize that aspects of the invention may be configured to specific applications in a quick and easy manner. For instance, a engagement device may include more than two fans thereon to achieve the pick-and-place operation. Other configurations are also possible that are within the scope of the invention.

With reference to FIG. 12, housing 30a of engagement device 20a may be configured such that the package 12a is positioned within a shroud portion 70 of the housing 30a. For example, in the previous embodiment, the engagement device 20 was configured to couple to an exposed surface of the package 12, but not necessarily around the package 12. In this embodiment, however, the housing 30a (e.g., shroud portion 70) may be configured so as to essentially cover the package 12 at least along a top portion thereof. To this end, the cavity 38a of shroud portion 70 may have a size and shape suitably chosen in relation to the package 12a such that the package 12a can fit within the perimeter thereof. Accordingly, the likelihood of slippage or sliding movement of the package 12a relative to engagement device 20a is eliminated or reduced. Moreover, because of the high volume of airflow around the sides of the package 12a, the package 12a is more securely retained to engagement device 20a. Thus, the shroud portion 70 allows for more consistent pick-and-place operations on irregular, non-uniformly shaped packages. Those of ordinary skill in the art will readily appreciate that the package 12a does not have to be completely within the cavity 38a of shroud portion 70. For example, a lower portion of the package 12a may extend below the first end 36a of the engagement device 20a, but have at least a portion of the edges of the package inboard of the engagement device 20a. Like the housing 30 of the embodiment of FIGS. 1-8, housing 30a may also include a grid member 62a providing the same or similar functionality as that described above for grid member 62. In one embodiment, the shroud portion 70 may be formed integral with housing 30a and engagement device 20a, as shown in FIG. 12. Alternatively, however, the shroud portion 70 may be formed as a separate element and capable of being removably coupled to the housing 30a. With the shroud portion 70 removed, engagement device 20a may be coupled to one of the exposed surfaces of the package 12a in a manner similar to engagement device 20 and package 12 described above.

While the present invention has been illustrated by a description of various embodiments and while these embodiments have been described in some detail, it is not the intention of the Applicants to restrict or in any way limit the scope of the appended claims to such detail. Additional advantages and modifications will readily appear to those skilled in the art. For example, the engagement device as described herein may be adapted to a wide variety of applications where it is desirable to operate on a package. In one embodiment, the engagement device may be adapted to a bucket, auxiliary device, or other substrate or surface to secure a package thereto, to prevent or reduce bouncing and other undesired movements of a package, or to achieve additional control over a package. In this regard, while aspects of the invention have been described herein with robots, pick-and-place devices, etc., aspects of the invention may be used in other areas of the packaging industry. Thus, the engagement member may be a carrier, and instead of a robot or pick-and-place device, the transport member may be hard automation transfers. Those of ordinary skill in the art will recognize other applications where the engagement device will prove beneficial in operating on a package.

Additionally, while the embodiments of the invention described herein utilize electric motors for the pressure generator, those skilled in the art will recognize that other motor types, such as pneumatic motors, are within the scope of this disclosure. Further, while the pressure generator (e.g., fan 40) is shown and described as being carried by the engagement device itself, the pressure generator may be spaced therefrom a small amount and coupled to the engagement device via a fluid conduit line. In such an embodiment, however, the spacing between the engagement device and pressure generator cannot be so great as to significantly impact response times or other performance indicators and therefore diminish the benefits gained by the design disclosed herein.

Accordingly, the various features of the invention may be used alone or in numerous combinations depending on the needs and preferences of the user.

What is claimed is:

1. A device for operating on a package, comprising:
a housing adapted to be coupled to the package; and
at least one fan coupled to said housing for generating a vacuum within the housing so as to selectively retain or release the package relative to the housing.

2. The device of claim 1, wherein said fan comprises:
a fan housing;
a blade assembly having a plurality of blades and disposed in the fan housing; and
a motor coupled to the blade assembly for rotating the blades so as to induce an airflow sufficient to generate a vacuum.

3. The device of claim 2, wherein said blades are movable so as to vary a leading angle of the blades.

4. The device of claim 2, wherein the motor is one of an electric motor or a pneumatic motor.

5. The device of claim 1, further comprising:
two fans coupled to said housing and cooperating to selectively retain or release the package relative to the housing.

6. The device of claim 1, wherein the housing includes a removable shroud portion.

7. The device of claim 1, wherein the fan is carried by the housing.

8. A system for transporting a package, comprising:
a transport member having an engagement member configured for moving between a first and second position;
a housing including a first end and a second end, said first end adapted to be coupled to the package, said second end coupled to said engagement member; and
at least one fan coupled to said housing, wherein actuation of said at least one fan generates a vacuum within said housing for selectively retaining or releasing the package relative to the first end of the housing.

9. The system of claim 8, wherein said fan is carried by the housing.

10. The system of claim 8, wherein said transport member includes a robot.

11. The system of claim 8, wherein said engagement member includes an extension arm.

12. A method of operating on a package, comprising:
decreasing a distance between a housing and the package;
actuating a fan coupled to the housing to generate a vacuum in the housing;
retaining the package relative to the housing using the vacuum generated by the fan; and
releasing the vacuum in the housing to release the package relative to the housing.

13. The method of claim 12, wherein actuating the fan includes energizing the fan to generate the vacuum in the housing and releasing the vacuum in the housing includes de-energizing the fan to release the vacuum in the housing.

14. The method of claim 12, wherein actuating the fan includes increasing a leading angle of blades of the fan to generate the vacuum in the housing and releasing the vacuum in the housing includes decreasing a leading angle of the blades of the fan to release the vacuum in the housing.
